(19) United States
(12) Patent Application Publication
(10) Pub. No.: US 2013/0302593 A1
(43) Pub. Date: Nov. 14, 2013

(54) Process to Produce Atomically Thin Crystals and Films

(71) Applicants: Jonathan Coleman, Dublin (IE); Ronan Smith, Dublin (IE); Mustafa Lotya, Dublin (IE)

(72) Inventors: Jonathan Coleman, Dublin (IE); Ronan Smith, Dublin (IE); Mustafa Lotya, Dublin (IE)

(73) Assignee: The Provost, Fellows, Foudation Scholars, and the Other Members of Board of the College of the Holy, Dublin (IE)

(21) Appl. No.: 13/820,293

(22) PCT Filed: Sep. 2, 2011
(86) PCT No.: PCT/EP11/65223

§ 371 Date: Jul. 30, 2013

(30) Foreign Application Priority Data
Sep. 3, 2010 (GB) 1014654.6

(51) Int. Cl. B01J 19/10

(52) U.S. Cl. CPC B01J 19/10
USPC 428/323; 427/565; 106/287.24; 106/287.18; 106/287.19

(57) ABSTRACT

The invention provides a process for exfoliating a 3-dimensional layered material to produce a 2-dimensional material, said process comprising the steps of mixing the layered material in a water-surfactant solution to provide a mixture wherein the material and atomic structural properties of the layered material in the mixture are not altered; applying energy, for example ultrasound, to said mixture; and applying a force, for example centrifugal force, to said mixture. The invention provides a fast, simple and high yielding process for separating 3-dimensional layered materials into individual 2-dimensional layers or flakes, which do not re-aggregate, without utilising hazardous solvents.

### FIELD OF THE INVENTION

The invention relates to atomically thin 2-dimensional materials. In particular, the invention relates to 2-dimensional materials for use in electronic, semiconductor, and/or insulating devices.

### BACKGROUND TO THE INVENTION

A wide range of 2-dimensional (2-D) atomic crystals exist in nature. The simplest is graphene (an atomic-scale 2-D honeycomb lattice of carbon atoms), followed by Boron Nitride (BN). However, hundreds more exist including transition metal dichalcogenides (TMDs) such as Molybdenum disulphide (MoS₂), Niobium diselenide (NbSe₂), Vanadium telluride (VTe₂), transmission metal oxides such as Manganese dioxide (MnO₂) and other layered compounds such as Bismuth telluride (Bi₂Te₃). Depending on the exact atomic arrangement, these crystals can be metals, insulators or semiconductors. The semiconductors can have a range of possible band gaps, as is illustrated in the following table for transition metal dichalcogenides:

TABLE 1
Electronic properties of Transition metal chalcogenides.
These materials can be semiconductors or metals.

| | | | |
|---|---|---|---|
| Table 1 | —S₂ | —Se₂ | —Te₂ |

| Gp 4 Ti, Zr, Hf | Diamagnetic Semiconductors | |
|---|---|---|
| | E_{g} ~0.2-2 eV, σ < 100 S/m | |
| Gp 5 V, Nb, Ta | Narrow band metals | |
| | σ ~10⁴-10⁶ S/m | |
| | 1T: TaS₂/Se₂ may be semiconducting | |
| Gp 6 Cr, Mo, W | Diamagnetic Semiconductors | |
| | E_{g} ~1-2 eV, σ < 100 S/m | |
| Gp 7 Tc, Re | Small gap semiconductors | |
| Gp 10 Ni, Pd, Pt | Semiconducting | Metallic |
| | E_{g} ~0.5 eV, σ ~100 S/m | σ ~10⁷ S/m |

In fact these materials cover the entire spectrum of electronic materials and so have potential as the basic building blocks of nanoscale circuits. Furthermore, some of these 2-D crystals, for example Antimony telluride (Sb₂Te₃) have very important properties such as high thermoelectric efficiency that can be used to turn waste heat to electricity. Others such as Bi₂Te₃ are topological insulators, a new class of material with unique properties. As all 2-D atomic crystals (flakes) tend to stack together to form 3-dimensional crystalline layered compounds, such materials are not commonly used in the electronics industry, except in some niche applications. The reason for this is that all 2-D atomic crystals tend to stack together to form 3-D crystalline layered compounds. The main problem is that the layers are virtually impossible to separate into their individual layers. The only method that exists to separate them into individual layers involves lithium intercalation, a technique which is described in U.S. Pat. No. 4,822,590 (Morrison et al.) having a filing date of 23 Apr. 1986. The technique described in Morrison is time consuming and cannot be performed in ambient conditions as it must be performed under inert atmospheric conditions (for example, in a glove box). Further, the procedure does not give an exfoliated version of the starting compound but rather a lithiated version which has the undesirable side-effect of changing the physical and electronic properties of the end product. This method does not work for well for all layered material and so cannot be considered a general method. Aside from these problems, when the lithium is removed the flakes re-aggregate, which is undesirable.

Layered materials, come in many varieties with one family having the formula MXₙ (where M=Ti, Zr, Hf, V, Nb, Ta, Cr, Mn, Mo, W, Tc, Re, Ni, Pd, Pt, Fe, Ru; X═O, S, Se, Te; and 1≦n≦3). A common group are the transition metal dichalcogenides (TMDs) which consist of hexagonal layers of metal atoms sandwiched between two layers of chalcogen atoms. While the bonding within these tri-layer sheets is covalent, adjacent sheets within a TMD crystal are weakly bound by van der Waals interactions. Depending on the co-ordination and oxidation state of the metal atoms, TMDs can be metallic or semiconducting. For example, Tungsten disulphide (WS₂) is a semiconductor while Tantalum disulphide (TaS₂) and Platinum telluride (PtTe₂) are metals. In addition, superconductivity and charge density wave effects have been observed in some TMDs, for example as published in a paper by F. Clerc et al. (F. Clerc, C. Battaglia, H. Cercellier, C. Monney, H. Berger, L. Despont, M. G. Gamier, P. Aebi, J. Phys.-Condes. Matter 2007, 19, 170). This versatility makes them potentially useful in many areas of electronics.

However, like graphene, they must be exfoliated to fulfil their full potential. While this can be done mechanically on a small scale, liquid phase exfoliation methods are required for any realistic applications. TMDs can be exfoliated by ion intercalation. However, this method is time consuming, extremely sensitive to the environment and incompatible with the majority of solvents and so is unsuitable for most applications. Furthermore, removal of the ions results in re-aggregation of the layers (R. Bissessur, J. Heising, W. Hirpo, M. Kanatzidis, Chemistry of Materials 1996, 8, 318).

Recently, it has been showed that graphite can be exfoliated to give graphene by sonication in certain solvents (Y. Hernandez, V. Nicolosi, M. Lotya, F. M. Blighe, Z. Y. Sun, S. De, I. T. McGovern, B. Holland, M. Byrne, Y. K. Gun'ko, J. J. Boland, P. Niraj, G. Duesberg, S. Krishnamurthy, R. Goodhue, J. Hutchison, V. Scardaci, A. C. Ferrari, J. N. Coleman, Nature Nanotechnology 2008, 3, 563). This method is non-destructive, insensitive to air and water and gives defect free graphene at high yield. However, many of these solvents are unsuitable for use in most applications due to (i) having high boiling points (e.g. N-methyl pyrrolidone), which makes them difficult to remove, and (ii) being highly toxic to the environment (e.g. di-methyl-formamide).

However, it is widely expected that this route cannot be extended to other layered compounds such as TMDs. Graphene exfoliation relies on the matching of the surface energies of solvent and graphene. In both case these are ˜70 mJ/m². This is at the upper range of surface energy for solvents. However, TMDs such as MoS₂ and WS₂ have surface energy of >200 mJ/m² [K. Weiss, J. M. Phillkips, Physical Review B, 1976, 14, 5392]. No solvent has surface energy this high making the exfoliation mechanism used for graphene unlikely to work for TMDs.

There is therefore a need to provide two-dimensional atomic crystals suitable for use in electronic, semiconductor, and/or insulating devices by a suitable method or process to overcome the above-mentioned problems.

### SUMMARY OF THE INVENTION

According to the present invention there is provided, as set out in the appended claims, a process for exfoliating 3-dimensional layered material to produce a 2-dimensional material, said process comprising the steps of:
mixing the layered material in a water-surfactant solution to provide a mixture;
applying energy, for example ultrasound, to said mixture; and
applying a force, for example centrifugal force, to said mixture,
wherein the material and/or atomic structural properties of the layered material in the mixture are not altered during said process.

An important aspect of the present invention is that no hazardous chemicals are used to carry out the invention and the solvent is water. The process is safe, non-combustable and involves benign materials. The use of water avoids disposal or recycling of large quantities of potentially hazardous solvents. In addition, the number of steps involved in the method is less than the methods of the prior art. The surfactant molecules interact with the layered materials by van der Waals interactions. The interaction between the surfactant and the layered material in the mixture does not change or alter the (atomic) structural or material properties of the layered material in any significant way, which is the opposite to the technique described in U.S. Pat. No. 4,822,590 (Morrison et al.). The process of the present invention is also quick, easy and can be reproduced in any laboratory. No glovebox or climate control is required.

Following the step of applying energy the mixture comprises a dispersion of 2-dimensional atomic crystals. The layered material may be any 3-dimensional layered compound, for example transition metal dichalcogenide having the formula MXₙ or any other layered material such as transition metal oxides, boron nitride (BN), Bi₂Te₃, Sb₂Te₃, TiNCl, or any other inorganic layered compound. When the 3-dimensional transition metal dichalcogenide has the formula MXₙ, M may be selected from the group comprising Ti, Zr, Hf, V, Nb, Ta, Cr, Mn, Mo, W, Tc, Re, Ni, Pd, Pt, Fe and Ru; X may be selected from the group comprising O, S, Se, and Te; and 1≦n≦3.

In one embodiment of the invention, the process may further comprise the step of allowing the formation of a thin film layer from said mixture. The step of forming the thin film layer is formed by vacuum filtration. It will be understood by those skilled in the art that other means may be used to form the thin film later, for example, by dip coating, Langmuir-Blodgett coating, spray coating, gravure coating, spin coating or other means.

In a further embodiment of the present invention, the process may further comprise the step of coating a substrate with the mixture. The step of coating may comprise spray coating, dip coating or Langmuir Blodgett deposition.

The water-surfactant solution of the present invention may comprise a solution of sodium cholate (NaC) or any other type of surfactant known to those skilled in the art, for example, but not limited to, sodium dodecylsulphate (SDS), sodium dodecylbenzenesulphonate (SDBS), lithium dodecyl sulphate (LDS), deoxycholate (DOC), taurodeoxycholate (TDOC), IGEPAL CO-890 (IGP), Triton-X 100 (TX-100), and water. In this instance, the NaC in water may be used at a concentration of 1.5 mg/ml (w/v). The advantage of a water-based exfoliation process is that it is safe in terms of personal safety, is simple and easy to perform, and is environmentally friendly. The water-based exfoliation process of the present invention may be performed in a matter of minutes, whereas lithium intercalation exfoliation takes days. This is a significant improvement in terms of time and cost savings. Furthermore, exfoliation using surfactants can be achieved in ambient conditions without the need for a glove box or an inert atmosphere, unlike that of lithium intercalation exfoliation which must be carried out in an inert environment.

As a result of the need for an inert environment and the time taken for the process to reach completion, lithium intercalation is difficult to scale-up on an industrial level. However, the process of the present invention is based on the use of a water- and surfactant-based exfoliation process, without the need of an inert environment as explained above. As such, the process of the present invention may be scaled-up to an industrial level, providing a new and significantly improved means to obtain 2-dimensional crystals (flakes) and thin films of transition metals.

The results illustrated herein show the exfoliated material to be MoS₂ with a structure similar to the starting material. There are no structural distortions as are found with ion intercalated MoS₂, as per prior art methods, such as the method outlined in Morrison et al. This point is important as it means the material properties are not modified by the exfoliation process (as distinct to the end result of being exfoliated). The mixing method of the invention is such that the surfactant molecules interact with the layered materials by van der Waals interactions. Such interactions are known to only perturb the electronic properties of dispersed nano-materials very slightly as evidenced by many studies on the optical properties of surfactant stabilised carbon nanotubes. Raman spectroscopy of surfactant exfoliated flakes show the material to be of the same 2H-polytype as the bulk starting material. This demonstrates that interaction with the surfactant has not changed the structure or material properties in any significant way.

In addition, a wide range of surfactants can be used and importantly, the surfactant concentration is not critically important; the process will work well so long as there is an excess of surfactant.

Another important aspect is safety. The process is safe, non-combustable and involves benign materials. In addition, using water avoids disposal or recycling of large quantities of solvents. In addition, the vast majority of surfactant can be removed before applications.

In another embodiment of the present invention, there is provided a device comprising a mixture of layered material in a water-surfactant solution. The device may be a thin film of transition metal dichalcogenides in a water-surfactant solution on a substrate, or the device may be a component coated with the solution. The device may be selected from, but not limited to, the group comprising electrodes, transparent electrodes, capacitors, transistors, solar cells, light emitting diodes, thermoelectric devices, dielectrics, batteries, super capacitors, nano-transistors, nano-capacitors, nano-light emitting diodes, and nano-solar cells.

In a further embodiment of the present invention, there is provided a hybrid film utilising a mixture of layered materials in a water-surfactant solution and a mixture of conducting nanostructures in a water-surfactant solution, produced according to the process of the present invention. The conducting nanostructures may be selected from the group comprising graphene, single-walled carbon nanotubes, multi-walled carbon nanotubes, metallic inorganic layered materials (e.g. NbSe₂, TaS₂ and the like), metallic nanowires (e.g. gold, silver, platinum, palladium, cobalt, nickel, lead and the like) or metallic 2-dimensional nanoflake (e.g. gold, silver, platinum, palladium, cobalt, nickel, lead and the like).

The production of crystals (flakes) and thin films of the present invention provide an invaluable source of metallic, semiconducting, or insulating material for use in the preparation of electronic and nano-electronic devices.

### BRIEF DESCRIPTION OF THE DRAWINGS

The invention will be more clearly understood from the following description of an embodiment thereof, given by way of example only, with reference to the accompanying drawings, in which:

FIG. 1 shows a flow chart illustrating the process steps to prepare separated two-dimensional atomic crystals according to the present invention;

FIG. 2 illustrates an optical absorption spectrum of Molybdenum disulphide (MoS₂), as measured (top graph) and with the background subtracted (bottom graph);

FIG. 3 illustrates transmission electron microscope (TEM) images of exfoliated MoS₂ flakes consisting of very few stacked atomic crystals;

FIG. 4 illustrates Zeta potential (mV) results for the surfactant alone and the surfactant-coated MoS₂ flakes dispersed in water;

FIG. 5 illustrates a scanning electron microscope (SEM) image of a MoS₂ film;

FIG. 6 illustrates MoS₂ based films and hybrids. a. Inset: A photograph of a thin (100 s of nm) MoS₂ film. Main image: An SEM image of the surface of a thin MoS₂ film. b. An absorption spectrum of the film in a. Inset: The same absorption spectrum with the background (dashed line) subtracted. c. Raman spectra of both the film in a and the starting powder. d and e. Photograph and SEM image of a thin MoS₂/SWNT hybrid film. f. Electrical properties of MoS₂/graphene and MoS₂/SWNT hybrid films as a function of mass fraction, M_{f} (thickness ˜200 nm for MoS₂/graphene films and ˜50 μm for MoS₂/SWNT films). g. Thermoelectric power factor, S² σ_{DC} (S is Seebeck coefficient) for MoS₂/SWNT hybrid films as a function of SWNT M_{f} (thickness ˜50 μm). The value for MoS₂ was 0.02 μW/mK². Lithium capacity as a function of charge/discharge cycle number for Li ion batteries with MoS₂/SWNT and MoS₂ films as the cathode. In each case the anode was lithium while the electrolyte was LiPF₆ in ethylene carbonate/diethyl carbonate. Inset: Coulombic efficiency (%) as a function of cycle number;

FIG. 7 illustrates impedance plots for electrodes containing MoS₂-CNT and bare MoS₂ thin film electrodes. The frequency range applied was 100 kHz-0.01 Hz; and

FIG. 8 illustrates the dispersion of other inorganic layered compounds. a). Photograph of dispersions of WS₂, MoTe₂, MoSe₂, NbSe₂, TaSe₂ and BN all stabilised in water by sodium cholate. b). absorption spectra of dispersions shown in a. c). Vacuum filtered thin films of BN, TaSe₂, WS₂, MoTe₂, MoSe₂ and NbSe₂ (the BN film is shown supported by a porous cellulose membrane) d)-i). TEM images of flakes deposited on TEM grids from the dispersions in a). j). TEM image of a MnO₂ flake stabilised in water using sodium cholate. Such flakes were both exfoliated from a MnO₂ nanoparticulate powder where flakes were found as a minority phase. k) A SEM image of an MnO₂ flake on a TEM grid. Energy dispersive X-ray spectral analysis, taken in the region marked by the box, confirmed the composition of this flake to be very close to MnO₂.

### DETAILED DESCRIPTION OF THE DRAWINGS

This invention provides a fast, simple and high yielding process for separating multilayered 3-D crystalline compounds (for example, TMDs) into individual 2-dimensional layers or flakes, which do not re-aggregate, without utilising hazardous solvents. The separated 3-dimensional crystalline layered compound (for example, TMDs) can be formed into thin films, quickly, inexpensively and easily from liquid dispersions. The thin films have metallic, semiconducting or insulating properties, depending on the starting material. These 2-dimensional materials are ideal building blocks for nano-electronic devices. For example, where the 2-D crystals of the present invention in thin film form are metallic, semiconducting or insulating, they can be used for, respectively:
(i) electrodes or transparent electrodes in displays, windows, capacitors, devices etc.
(ii) devices such as transistors, solar cells, light emitting diodes, thermoelectric devices;
(iii) dielectrics in capacitors, gate dielectrics in transistors, etc.; and
(iv) electrodes or other parts in batteries or super-capacitors etc.

Where the 2-D crystals of the present invention in individual flake form are metallic, semiconducting or insulating, they can be used for, respectively:
(i) electrodes in nanoscale devices such as nano-transistors, nano-capacitors, nano light emitting diodes, nano solar cells, etc.;
(ii) active layers in nano-devices such as nano transistors, nano solar cells, nano light emitting diodes, etc.; and
(iii) dielectrics in nano capacitors, gate dielectrics in nano transistors, etc.

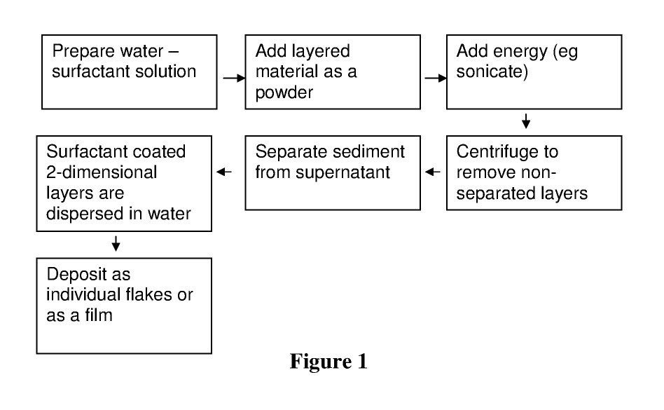

FIG. 1 shows a flow chart illustrating the process steps to make the separated TMDs according to the invention, which is now described in more detail in one preferred embodiment of the invention.

Powdered MoS₂ (Sigma Aldrich [5 mg/ml]) is added to a solution of the surfactant Sodium Cholate (NaC) in water (1.5 mg/ml). This mixture is sonicated (Sonics VX-750 ultrasonic processor with flat head tip, at 750 W) using a sonic tip for 0.5 hours (30 minutes). The dispersion is then centrifuged at 1500 RPM for 90 minutes (Hettich Mikro 22R centrifuge) and the supernatant removed for further analysis.

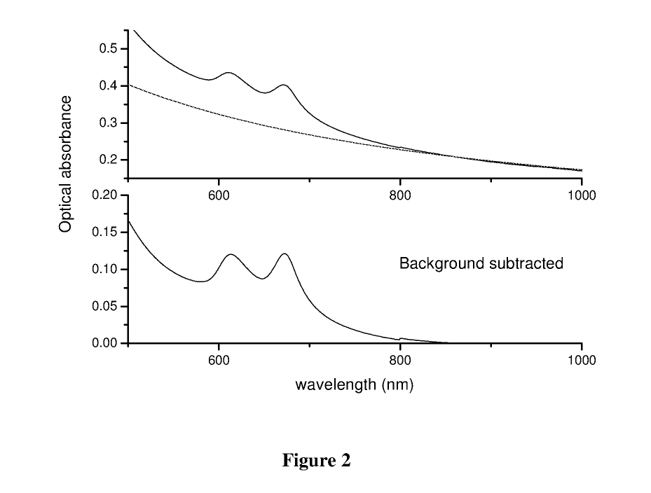

Following centrifugation, the supernatant (a MoS₂ dispersion) appears as a black liquid. The MoS₂ dispersion is diluted by a factor of 10 with a water/surfactant mixture (NaC at 1.5 mg/ml), and the colour of the dispersion becomes paler, which permits measurement of an absorption spectrum. To qualify that the diluted supernatant is a MoS₂ dispersion, an optical absorption spectrum of the diluted dispersion is performed, the result of which is shown in FIG. 2 (Spectrometer: Cary 6000i; Wavelength range: 0 nm to 1000 nm; Control: a cuvette filled with NaC solution).

In the top graph of FIG. 2, the substantially linear line represents a power law curve extrapolated from the high wavelength (low energy) region of the spectrum. This indicates the presence of a background reading due to light scattering in the dispersion. When the background reading is subtracted (power law), the spectrum as shown in the lower graph of FIG. 2 is obtained. The shape of this spectrum, in particular the peaks at 620 nm and 690 nm, are indicative of MoS₂. In fact, the absorption spectrum for the MoS₂ flakes shown in FIG. 2 is consistent with a semiconducting material in accordance the values outlined in Table 1 above.

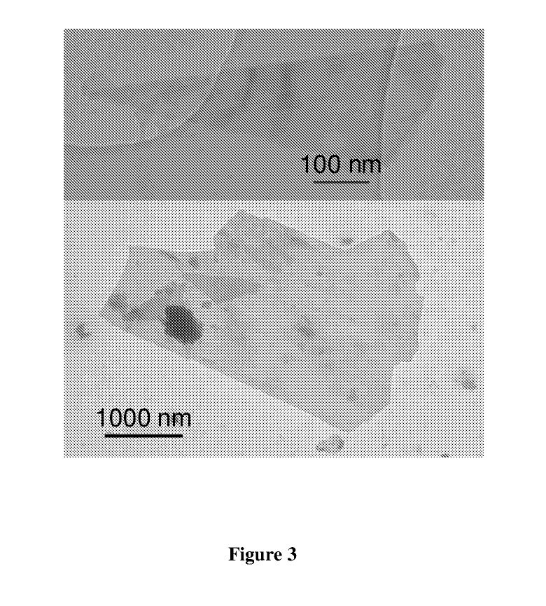

In order to determine whether the MoS₂ is dispersed in the water surfactant solution as 3-dimensional crystallites, monolayers or small aggregates of a few stacked layers (as is generally the case for graphene in certain surfactants), small quantities of dispersed MoS₂ are dropped onto transmission electron microscope (Jeol 2100, operated at 200 kV) grids and TEM analysis is performed. The results of the TEM analysis are shown in FIG. 3 and are typical TEM images of objects observed in the microscope. In all cases, very thin flakes rather than 3-D crystallites are observed. Analysis of the edges of these objects shows them to be no more than a few layers thick.

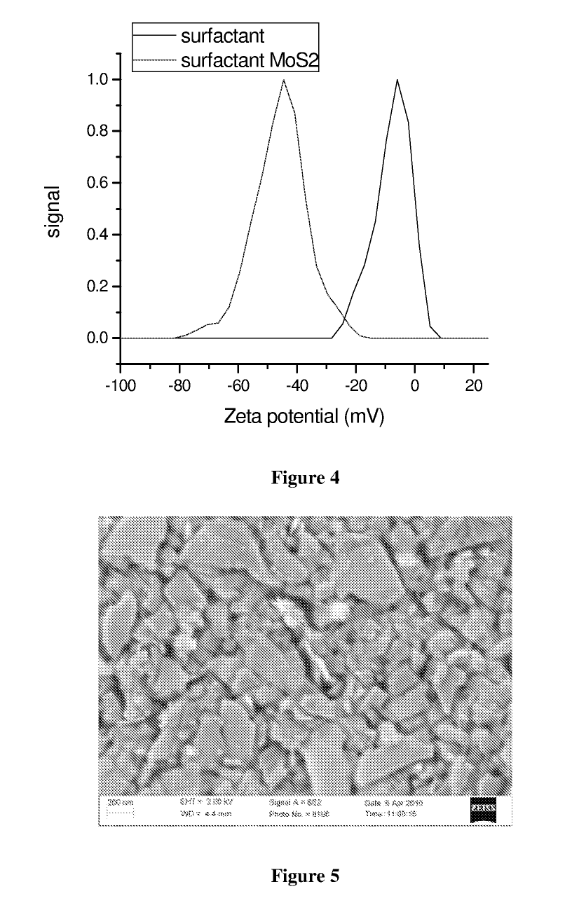

To determine whether the surface of the dispersed flakes of MoS₂ provide electrical potentials, zeta potential analysis was performed using a Malvern Zetasizer Nano system with irradiation from a 633 nm He—Ne laser. Zeta potential analysis provides data indicating whether surfaces are electrically charged and whether such charges are negative or positive. The zeta potential results of the dispersed flakes of MoS₂ are shown in FIG. 4. The peak at −50 mV shows that these surfactant coated flakes produced by the method of the claimed invention are negatively charged, as would be expected from the structure of the surfactant NaC. This confirms that the surfactant is sticking on the flakes and stabilising them, which prevents the flakes from re-aggregating.

To test whether the MoS₂ dispersions can produce thin films, MoS₂ dispersions are vacuum filtered through a 25 nm pore size membrane (Millipore nitrocellulose membranes ˜25 nm pore size). A thin film is formed on the membrane, which when analysed by a Scanning Electron Microscope (SEM; Zeiss Ultra Plus Scanning Electron Microscope) is shown to consist of randomly ordered MoS₂ flakes (see FIG. 5). The SEM images show that such films are semiconducting and are useful for preparing electronic devices such as thin film transistors, solar cells, light emitting diodes etc.

An advantage of the present invention is that the dispersed flakes could be deposited as individual flakes onto substrates using methods such as spray casting or Langmuir Blodgett deposition, as is known for deposition of graphene oxide from water. In addition, these individual flakes can be used to prepare nano-electronic devices such as transistors.

The production of dispersed flakes and thin films from the method described above is a critical advance in the field of the present invention. The ability to exfoliate 3-dimensional crystalline layered compounds such as TMDs into nano-flakes allows the nano-flakes to be deposited on substrates. These flakes are ˜100 nm wide and ˜1-5 nm thick. This is approximately the size required to prepare nano-devices. The key point is that this is a general method which allows the production of flakes from materials which are metallic, semiconducting or insulating. Semiconducting flakes could be used for active layers in nano-transistors, nano-solar cells or other nano-devices. Metallic flakes can be used as nano-electrodes, while insulating flakes can be used as nano-dielectrics in transistors or capacitors for example. Thus these materials could be the building blocks of nano-electronics.

In conclusion, a method to exfoliate MoS₂ into very thin, few layer flakes by sonication in water-surfactant solutions has been devised. These flakes are stabilised by a surfactant coating and can easily be prepared into films and most likely deposited onto substrates as individual flakes.

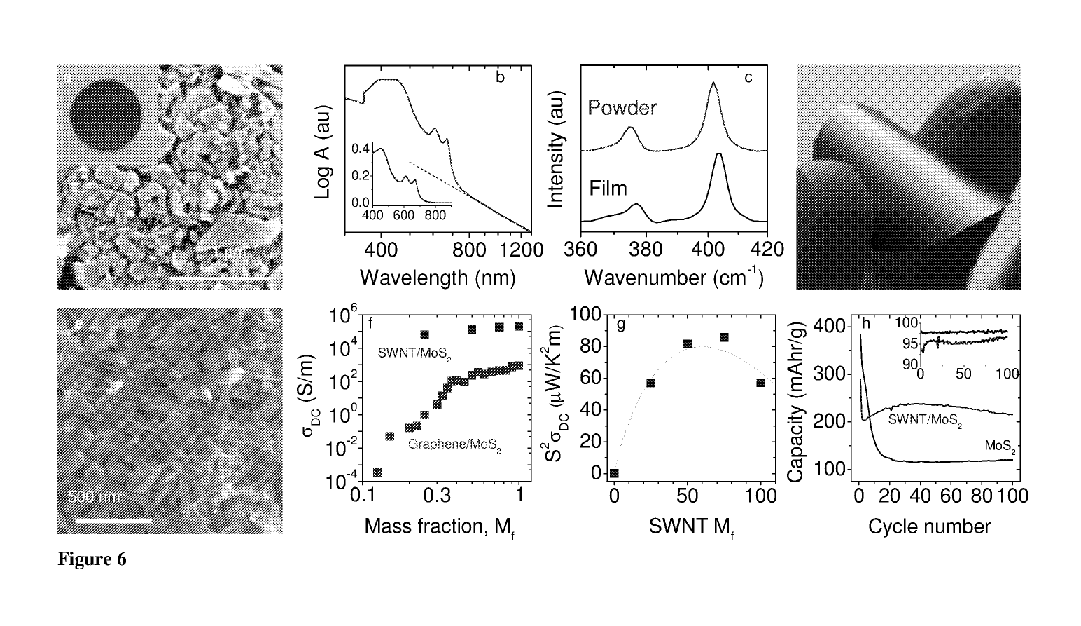

It will be appreciated that TMDs would be ideal for applications in thermoelectric devices, Li ion batteries or supercapacitors if their electronic conductivity was higher. However, the conductivity can be increased dramatically by incorporation of conducting nanostructures into the TMD films. In one embodiment Graphene and single walled nanotubes (SWNT) were exfoliated using the method of the present invention in aqueous sodium cholate solutions at known concentrations. These were then blended with an aqueous MoS₂/SC dispersion in various ratios to give MoS₂/graphene and MoS₂/SWNT dispersions with a range of compositions. These could then be formed into free standing films by vacuum filtration (FIG. 6d). SEM analysis shows the MoS₂/graphene films to be similar in morphology to the MoS₂-only films while for the MoS₂/SWNT films, the flakes appear to be embedded in the SWNT network (FIG. 6f). Addition of the nano-conductors increases the film conductivity, σ_{DC}, dramatically from ˜10⁻⁵ S/m for the MoS₂ alone to 1000 S/m for 100% graphene and 2×10⁵ S/m for 75% SWNTs (FIG. 6f).

Increasing the DC conductivity of nanostructured materials without degrading the Seebeck coefficient is an important goal in thermoelectric research. It has been demonstrated here that the Seebeck coefficient falls only slightly with nanotube content, remaining close to S=25 μV/K up to 75 wt % SWNT Importantly, the power factor increased with nanotube content (FIG. 6g), reaching S² σ_{DC}=87 μWm⁻¹K⁻² for 75 wt % before falling off at higher nanotube contents.

MoS₂/SWNT hybrids can also be used as cathodes in Li ion batteries. These hybrid electrodes show higher rate capability and higher retained capacity over 100 cycles when compared to MoS₂-only electrodes (FIG. 6h). The very high Coulombic efficiency (above 95%) of the MoS₂-CNT hybrid electrode suggests very good electrochemical performance

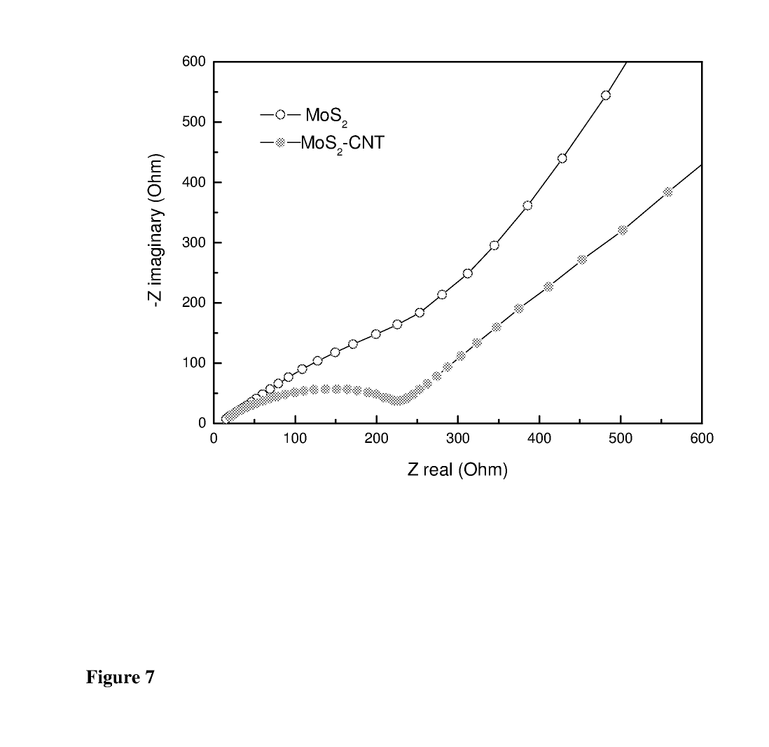

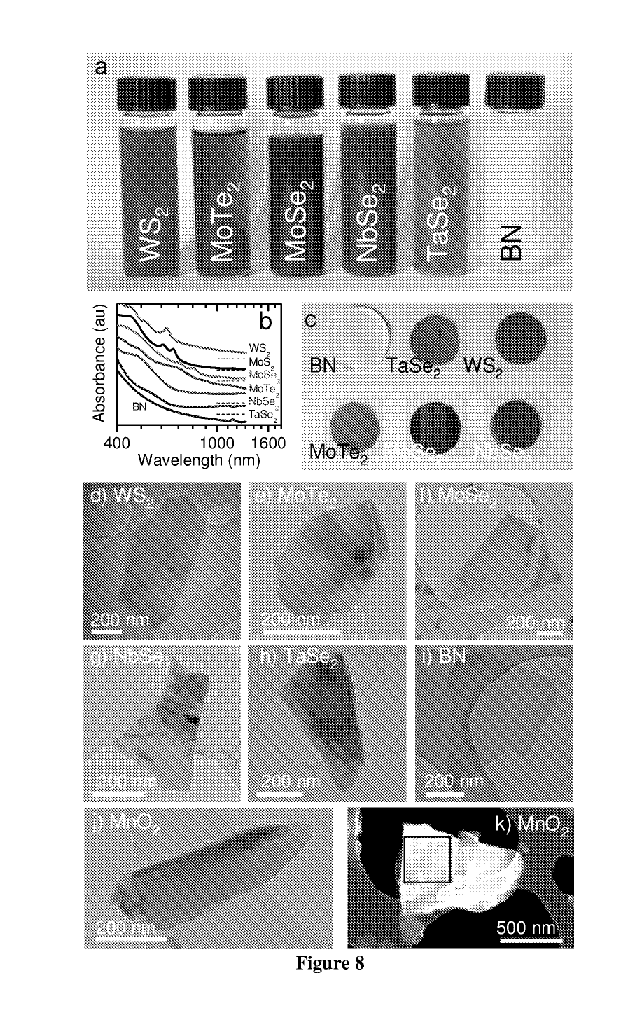

In order to verify that the CNT are responsible for the good electrochemical performance of the cell with the MoS₂-CNT, ac impedance measurements were conducted (FIG. 7). The Nyquist plots obtained for the bare MoS₂ and MoS₂-CNT electrodes were compared. To maintain uniformity, electrochemical impedance spectroscopy (EIS) experiments were performed on working electrodes in the fully charged state. At high frequencies, the impedance response exhibits one semicircular loop, and there is a sloping straight line in the low frequency regime. The intercept on the Z real axis in the high frequency region corresponds to the resistance of the electrolyte. The semicircle in the middle frequency range indicates the charge transfer resistance, which is a measure of the charge transfer kinetics. The inclined line in the low frequency region represents the Warburg impedance, which is related to solid-state diffusion of Li ions in the electrode materials. The results show that the charge-transfer resistance of the cell with the MoS₂-CNT electrode is lower than for the cell made from a pure MoS₂ electrode indicating that the novel composite can improve the electrochemical kinetics of the MoS₂ in rechargeable lithium batteries.

It should be understood by those skilled in the art that this method can be extended to exfoliate ALL 2-D atomic crystals, leading to the production of the building blocks of nano-electronics and a range of devices.

For example, FIG. 8 illustrates that this method is not limited to MoS₂ but can be extended to a wide range of layered compounds such as BN, WS₂, TaSe₂, MoTe₂, MoSe₂ and NbSe₂. For these materials, stable dispersions were prepared, (FIG. 8a). The absorption spectra of the dispersions were close to those expected for these materials (FIG. 8b). In addition, these dispersions could easily be formed into films by filtration (FIG. 8c). TEM examination showed reasonably well-exfoliated flakes in all cases (FIG. 8d-i). This illustrates the usefulness of this method by making electrical and optical measurements on an NbSe₂ film (thickness ˜200 nm). Transmittance (550 nm) of T=20% was measured, coupled with a sheet resistance of Rₛ=2.1 kΩ/square. By adding 10 wt % SWNTs, these properties improved to T=33% and Rₛ=67 Ω/square, significantly better than for graphene networks. This exfoliation method can also be extended to transition metal oxides. Flakes of MnO₂ have been exfoliated using this method (FIG. 8j&k), emphasising the generality of this method. Such materials will be important in applications such as supercapacitors.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail.

1. A process for exfoliating a 3-dimensional layered material to produce a 2-dimensional material said process comprising the steps of:
mixing the layered material in a water-surfactant solution to provide a mixture;
applying energy, for example ultrasound, to said mixture; and
applying a force, for example a centrifugal force, to said mixture,
wherein the material and atomic structural properties of the layered material in the mixture are not altered.

2. A process according to claim 1, wherein following the step of applying a force the mixture comprises a dispersion of 2-dimensional material.

3. A process according to claim 1 further comprising the step of allowing the formation of a thin film layer from said mixture.

4. A process according to claim 1, further comprising the step of allowing the formation of a thin film layer from said mixture and wherein the step of forming the thin film layer is formed by vacuum filtration.

5. A process according to claim 1 further comprising the step of coating a substrate with the mixture.

6. A process according to claim 1, further comprising the step of coating a substrate with the mixture and wherein the step of coating comprises spray coating or dip coating or Langmuir Blodgett deposition.

7. A process according to claim 1, wherein the water-surfactant solution comprises a solution of water and a surfactant selected from the group comprising sodium cholate (NaC), sodium dodecylsulphate (SDS), sodium dodecylbenzenesulphonate (SDBS), lithium dodecyl sulphate (LDS), deoxycholate (DOC), taurodeoxycholate (TDOC), IGEPAL CO-890 (IGP), Triton-X 100 (TX-100).

8. A process according to claim 7, wherein the surfactant is sodium cholate (NaC).

9. A process according to claim 1, wherein the 3-dimensional layered material is selected from the group comprising a transition metal dichalcogenide (TMD), transition metal oxides, boron nitride (BN), Bi₂Te₃, Sb₂Te₃, TiNCl, or any other inorganic layered compound.

10. A process according to claim 1, wherein the 3-dimensional layered material is selected from the group comprising a transition metal dichalcogenide (TMD), transition metal oxides, boron nitride (BN), Bi₂Te₃, Sb₂Te₃, TiNCl, and any other inorganic layered compound and the layered materials have the formula MXₙ, where 1≦n≦3.

11. A process according to claim 10, wherein M is selected from the group comprising Ti, Zr, Hf, V, Nb, Ta, Cr, Mn, Mo, W, Tc, Re, Ni, Pd, Pt, Fe and Ru and X is selected from the group comprising O, S, Se, and Te.

12. A device utilising a mixture of layered materials in a water-surfactant solution produced according to the process of claim 1.

13. A device according to claim 12 selected from the group comprising electrodes, transparent electrodes, capacitors, transistors, solar cells, light emitting diodes, thermoelectric devices, dielectrics, batteries, super-capacitors, nano-transistors, nano-capacitors, nano-light emitting diodes, and nano-solar cells.

14. A hybrid film utilising a mixture of layered materials in a water-surfactant solution and a mixture of conducting nanostructures in a water-surfactant solution, produced according to the process of claim 1.

15. A hybrid film according to claim 14, wherein the conducting nanostructures are selected from the group comprising graphene, single-walled carbon nanotubes, multi-walled carbon nanotubes, metallic inorganic layered materials, metallic nanowires or metallic 2-dimensional nanoflake.
